(19) United States
(12) Patent Application Publication
(10) Pub. No.: US 2005/0069331 A1
(43) Pub. Date: Mar. 31, 2005

(54) Return-to-zero optical transmission device

(76) Inventors: Jae-Hoon Lee, Seoul (KR); Seong-Taek Hwang, Pyeongtaek-si (KR); Sung-Bum Park, Suwon-si (KR); Ji-Chai Jeong, Seoul (KR)

Correspondence Address: CHA & REITER, LLC, 210 ROUTE 4 EAST STE 103, PARAMUS, NJ, 07652, US

(21) Appl. No.: 10/833,850

(22) Filed: Apr. 28, 2004

(30) Foreign Application Priority Data
Sep. 30, 2003 (KR) 2003-67894

(51) Int. Cl. H04B 10/04

(52) U.S. Cl. 398/188

(57) ABSTRACT

Disclosed is a return-to-zero (RZ) optical transmission device. A light source outputs a carrier wave. A precoder encodes an inputted non-return-to-zero (NRZ) electrical signal. A delay element delays the encoded signal. A Mach-Zehnder interferometer modulator has two electrodes. The Mach-Zehnder interferometer modulator configured to modulate phase and intensity of the carrier wave using respective output signals of the precoder the delay element applied, and output an RZ optical signal.

### CLAIM OF PRIORITY

This application claims priority to an application entitled “RETURN-TO-ZERO OPTICAL TRANSMISSION DEVICE,” filed in the Korean Intellectual Property Office on Sep. 30, 2003 and assigned Serial No. 2003-67894, the contents of which are hereby incorporated by reference.

### BACKGROUND OF THE INVENTION

1. Field of the Invention

The present invention relates to an optical transmission device, and more particularly to a return-to-zero (RZ) optical transmission device enabling an optical receiver to have high reception sensitivity and be immune to the non-linearity of an optical fiber.

2. Description of the Related Art

An optical transmission system based on dense wavelength division multiplexing (DWDM) transmits an optical signal consisting of a plurality of channels having different wavelengths to a single optical fiber. Consequently, transmission efficiency increased. A DWDM system that can transmit at least 100 channels has been commercialized. Research on a DWDM system that has a transmission speed of 10 Tbps or more for simultaneously transmitting at least 200 40-Gbps channels to the single optical fiber is being actively conducted.

Recently, return-to-zero (RZ) modulation has been shown to be an advantages method for optical modulation in the DWDM-based optical transmission system. The RZ modulation enables a larger amount of optical signal transmission in a unit of time and has higher performance. This is due because the shape of each pulse is constant in case of the RZ modulation in terms of characteristics of reception sensitivity and non-linearity of an optical fiber, in comparison with non-return-to-zero (NRZ) modulation.

Many methods for generating an RZ optical signal have been proposed.

A conventional methods include using: an NRZ data modulator, a modulator driven by a sine wave or an NRZ modulator, and a mode-locked laser. However, there are limitations of such conventional methods since they need a number of radio frequency (RF) drivers and also two modulators must be correctly synchronized.

Another conventional method converts an NRZ electrical signal into an RZ electrical signal and then drives a modulator. However, because this method must generate the RZ electrical signal, devices of very wide bandwidth are needed.

Another conventional method includes driving a phase modulator using an NRZ electrical signal and generating an RZ optical signal through an optical delay interferometer. Because this method uses a single modulator, a synchronization problem between the two modulators is reduced, and a duty cycle of an RZ generated optical signal is controlled according to a time delay of the optical signal. However, the optical signal cannot be variably delayed in the above method.

### SUMMARY OF THE INVENTION

Therefore, the present invention has been made to reduce or overcome the above problems. One object of the present invention to provide a return-to-zero (RZ) optical transmission device that can reduce the distortion of a signal due to non-linearity of an optical fiber and increase the reception sensitivity of an optical receiver.

It is another object of the present invention to provide a return-to-zero (RZ) optical transmission device that can be implemented using a single modulator, rather than a plurality of modulators.

In accordance with an aspect of the present invention, the above and other objects can be accomplished by the provision of a return-to-zero (RZ) optical transmission device, comprising: a light source for outputting a carrier wave; a precoder for encoding an inputted non-return-to-zero (NRZ) electrical signal; a delay element for delaying the encoded signal; and a Mach-Zehnder interferometer modulator configured to modulate phase and intensity of the carrier wave using respective output signals of the precoder and the delay element applied, and output an RZ optical signal.

Preferably, a pulse width of the RZ optical signal is adjusted according to magnitude of a time delay by the delay element.

Preferably, the RZ optical transmission device further comprises: a drive amplifier for amplifying the encoded signal so that the Mach-Zehnder interferometer modulator can be driven in response to the amplified encoded signal.

### BRIEF DESCRIPTION OF THE DRAWINGS

The present invention will be more clearly understood from the following detailed description taken in conjunction with the accompanying drawings, in which:

FIG. 1 is a schematic diagram of a return-to-zero (RZ) optical transmission device in accordance with one embodiment of the present invention;

FIG. 2 is a timing diagram illustrating the operation of a Mach-Zehnder interferometer modulator;

FIG. 3 is a timing diagram illustrating electrical signals applied to the Mach-Zehnder interferometer modulator and an output optical signal in accordance with the present invention; and

FIG. 4 is a waveform diagram illustrating magnitudes and phases of RZ optical signals of 40 Gbps delayed by 5 ps, 15 ps, and 25 ps.

### DETAILED DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. For the purposes of clarity and simplicity, a detailed description of known functions and configurations incorporated herein will be omitted as it may make the subject matter of the present invention unclear.

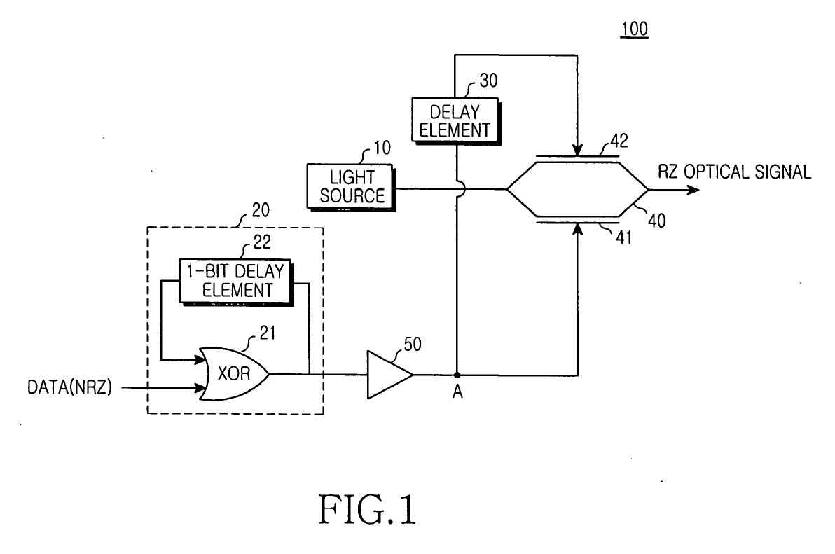

FIG. 1 is a schematic diagram of a return-to-zero (RZ) optical transmission device in accordance with one embodiment of the present invention.

Referring to FIG. 1, an RZ optical transmission device 100 in accordance with the present invention includes a light source 10 for outputting a carrier wave; a precoder 20 for encoding an inputted non-return-to-zero (NRZ) electrical signal; a delay element 30 for delaying the encoded signal; and a Mach-Zehnder interferometer modulator 40. The RZ optical transmission device 100 further includes a drive amplifier 50 for amplifying the encoded signal so that the Mach-Zehnder interferometer modulator 40 can be driven.

The light source 10 generates/outputs the carrier wave. It can be implemented by a laser diode (LD).

The precoder 20 encodes the inputted NRZ electrical signal. It is constituted by one exclusive OR (XOR) gate 21 and a 1-bit delay element 22.

The delay element 22 delays the encoded signal. The width of the generated an optical signal is controlled according to the delay magnitude.

The Mach-Zehnder interferometer modulator 40 includes two electrodes 41 and 42. An output signal of the precoder is applied to the electrode 41 of one side and an output signal of the delay element applied to the electrode 42 of the other side. Accordingly, the phase and intensity of the carrier wave are modulated and an RZ optical signal is outputted.

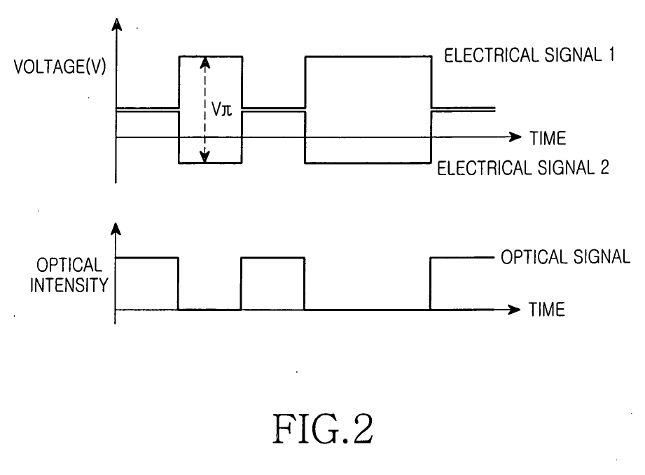

As shown in FIG. 2, where a difference between the first and second electrical signals applied to the electrodes 41 and 42 is an odd multiple of Vπ, destructive interference occurs. Consequently, the Mach-Zehnder interferometer modulator 40 does not output an optical signal. Furthermore, where the difference between the first and second electrical signals applied to the electrodes 41 and 42 is an even multiple of Vπ, constructive interference occurs. Consequently, the Mach-Zehnder interferometer modulator 40 outputs an optical signal.

The drive amplifier 50 amplifies the encoded signal. The modulator 40 is driven in response to the amplified encoded signal. The drive amplifier 50 is arranged between the precoder 20 and a node A. This embodiment includes one drive amplifier, but can include two drive amplifiers containing one drive amplifier arranged between the node A and the electrode 41 of one side and the other drive amplifier arranged between the delay element 30 and the electrode 42 of the other side.

Operation of the RZ optical transmission device as described above will now be described.

Referring again to FIG. 1, the precoder 20 constituted by the XOR gate 21 and the 1-bit delay element 22 encodes an NRZ electrical signal generated from a pulse pattern generator (PPG). The electrical signal encoded by the precoder 20 is sufficiently amplified so that the drive amplifier 50 can drive the modulator. The amplified signal is output from the node A to two paths. The signal output to one path is applied to the electrode 41 of one side in the Mach-Zehnder interferometer modulator 40. The signal output to the other path is delayed by the delay element 30. A result of the delay is applied to the electrode 42 of the other side in the Mach-Zehnder interferometer modulator 40.

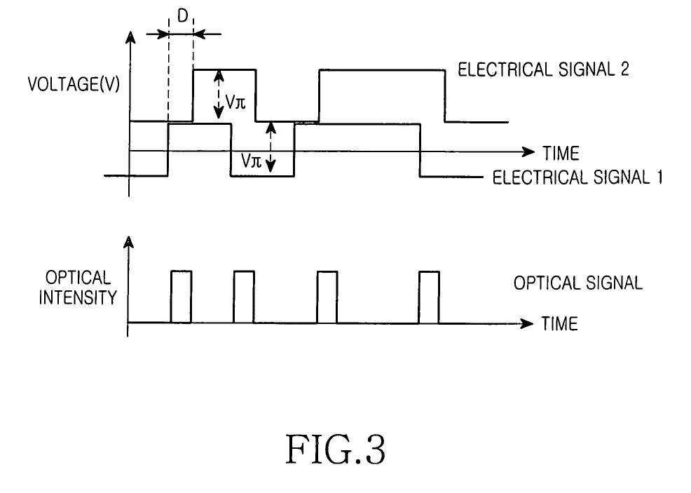

FIG. 3 shows the electrical signals and the output optical signal to be applied to the Mach-Zehnder interferometer modulator 40. In FIG. 3, a symbol “D” denotes a time difference between the first and second electrical signals according to the delay element's delay operation. When an appropriate time delay and bias voltage Vπ are applied, an optical signal is generated at only rising and falling edges of the electrical signal based on the time delay. An RZ optical signal can be generated as an output of the Mach-Zehnder interferometer modulator 40. Since an optical signal is generated at only the rising and falling edges, as described above, the duty cycle, the shape and the phase associated with the optical signal are changed according to the time delay.

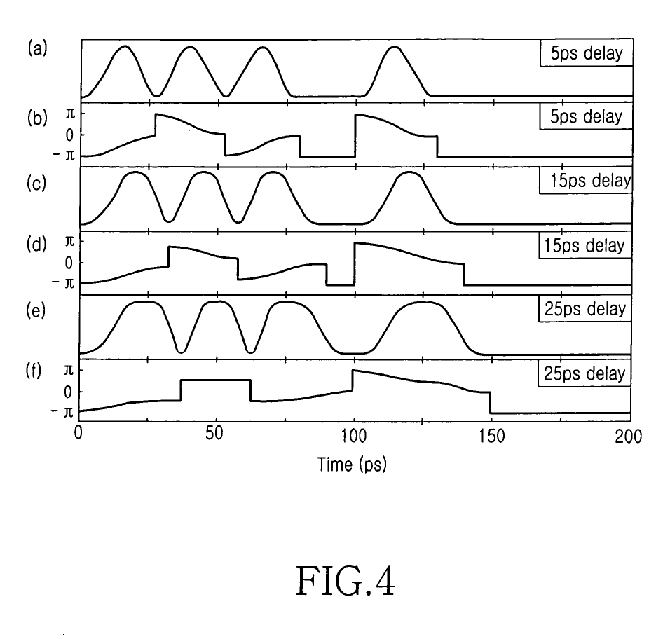

FIG. 4 is a waveform diagram illustrating magnitudes (indicated by (a), (c) and (e)) and phases (indicated by (b), (d) and (f)) of RZ optical signals of 40 Gbps delayed by 5 ps, 15 ps and 25 ps. The rising and falling edges are present in the NRZ electrical signal due to a limit of bandwidth of the electronic device. Thus, the shapes of optical signals to be output are different according to the time delay. In case of the time delay of 5 ps, the shapes of generated RZ signals are similar to each other irrespective of signal positions. However, where the time delay is as large as 25 ps, the shapes of RZ signals are different according to signal positions. Furthermore, the duty cycle of the RZ signal generated according to the time delay is changed. It can be found that the duty cycle of the RZ signal increases, as the time delay is large.

As is apparent from the above description, the present invention provides a return-to-zero (RZ) optical transmission device having a simplified structure because a single modulator is used. Because the RZ optical transmission device converts a non-return-to-zero (NRZ) electrical signal into an RZ electrical signal without an intermediate conversion operation, a signal synchronization operation is unnecessary.

In addition, since the RZ optical transmission device uses a time delay necessary for one modulator as a time delay of an electrical signal, an RZ optical transmitter can be easily implemented. Moreover, the duty cycle of an RZ signal is easily adjusted.

Although the preferred embodiments of the present invention have been disclosed for illustrative purposes, those skilled in the art will appreciate that various modifications, additions and substitutions are possible, without departing from the scope of the invention. Therefore, the present invention is not limited to the above-described embodiments, but the present invention is defined by the claims which follow, along with their full scope of equivalents.

1. A return-to-zero optical transmission device, comprising:
a light source for outputting a carrier wave;
a precoder for encoding an inputted non-return-to-zero electrical signal;
a delay element for delaying the encoded signal; and
a Mach-Zehnder interferometer modulator configured to modulate phase and intensity of the carrier wave using respective output signals of the precoder and the delay element applied.

2. The return-to-zero optical transmission device as set forth in claim 1, wherein the Mach-Zehnder interferometer modulator further outputs an RZ optical signal.

3. The return-to-zero optical transmission device as set forth in claim 1, wherein the Mach-Zehnder interferometer modulator includes two electrodes, one electrode coupled to the precoder and the other electrode coupled to the delay element.

4. The return-to-zero optical transmission device as set forth in claim 1, wherein a pulse width of the return-to-zero optical signal is adjusted using the magnitude of a time delay by the delay element.

5. The return-to-zero optical transmission device as set forth in claim 1, wherein the precoder comprises:
a bit delay element; and
an exclusive OR gate.

6. The return-to-zero optical transmission device as set forth in claim 5, wherein the bit delay element is an 1-bit delay element.

7. The return-to-zero optical transmission device as set forth in claim 1, further comprising:
a drive amplifier for amplifying the encoded signal so that the Mach-Zehnder interferometer modulator can be driven in response to the amplified encoded signal.
